(19) United States
(12) Patent Application Publication
(10) Pub. No.: US 2001/0028398 A1
(43) Pub. Date: Oct. 11, 2001

(54) Image pickup apparatus, information processing apparatus, image processing system, image processing method and memory medium

(76) Inventor: Fumiaki Takahashi, Kanagawa-ken (JP)

Correspondence Address: FITZPATRICK CELLA HARPER & SCINTO, 30 ROCKEFELLER PLAZA, NEW YORK, NY, 10112, US

(21) Appl. No.: 09/741,354

(22) Filed: Dec. 21, 2000

(30) Foreign Application Priority Data
Dec. 28, 1999 (JP) 11-374757

(51) Int. Cl. H04N 5/225

(52) U.S. Cl. 348/232; 348/335; 348/241

(57) ABSTRACT

In order to provide an image pickup device capable of providing a high quality image by enabling satisfactory image processing, a photographing device transmits photographed image information, obtained by photographing means, through photographing side communication means to an information processing device, which receives the photographed image information from the photographing device, by information processing side communication means, and, after image processing by image processing means, returns the photographed image information after the image processing to the photographing device by the information processing side communication means.

### BACKGROUND OF THE INVENTION

1. Field of the Invention

The present invention relates to a system composed of an image pickup apparatus such as a digital camera and an information processing apparatus connected with the image pickup apparatus in communicable manner. It also relates to an image pickup apparatus, an information processing apparatus, an image processing system and an image processing method for reproducing the photographed image in a more satisfactory manner, and a memory medium storing process steps for executing such method in a computer readable manner.

2. Related Background Art

The digital camera is conventionally equipped with an image pickup unit for acquiring a photographed (or image picked up) image of an object, an image processing unit for applying image processing to the photographed image acquired in the image pickup unit, and a storage unit for storing the photographed image after image processing in the image processing unit. As the photographed image itself obtained in the image pickup unit is not satisfactory in quality, the image processing unit of the digital camera is provided for improving the quality of such image.

However, the above-described conventional digital camera is not necessarily be capable of sufficiently executing the necessary image processing which requires a large amount of calculation and a large amount of work memories, because of limitations in the size of the main boy, in the electric power consumption and in the capacity of the storage unit.

For this reason, the quality of the photographed image can only be improved to a certain extent.

### SUMMARY OF THE INVENTION

An object of the present invention is to solve all the aforementioned drawbacks, or at least one thereof.

Another object of the present invention is to enable acquisition of the image after satisfactory image processing, even if the photographing apparatus is provided with the satisfactory image processing ability.

The above-mentioned objects can be attained, according to the present invention, by a photographing apparatus provided with an image pickup unit for photographing an object image through an optical system thereby acquiring image information of the object image, and a communication unit for transmitting the image information obtained in the image pickup unit to the exterior and receiving the image information after arbitrary image processing from the exterior.

Still other objects of the present invention, and the features thereof, will become fully apparent from the following description of embodiment, to be taken in conjunction with the accompanying drawings.

### BRIEF DESCRIPTION OF THE DRAWINGS

FIG. 1 is a block diagram showing the configuration of a digital camera system embodying the present invention in a first embodiment;

FIG. 2 is a view showing the function of the above-mentioned digital camera system;

FIG. 3 is a block diagram showing the configuration of a digital camera system embodying the present invention in a second embodiment;

FIG. 4 is a view showing the function of the above-mentioned digital camera system;

FIG. 5 is a view showing the function of a digital camera system in a third embodiment;

FIG. 6 is a view showing the file structure in a memory card of the above-mentioned digital camera; and

FIG. 7 is a view showing the function of the above-mentioned digital camera.

### DETAILED DESCRIPTION OF THE PREFERRED EMBODIMENTS

Now the present invention will be clarified in detail by embodiments thereof, with reference to the accompanying drawings.

[First Embodiment]

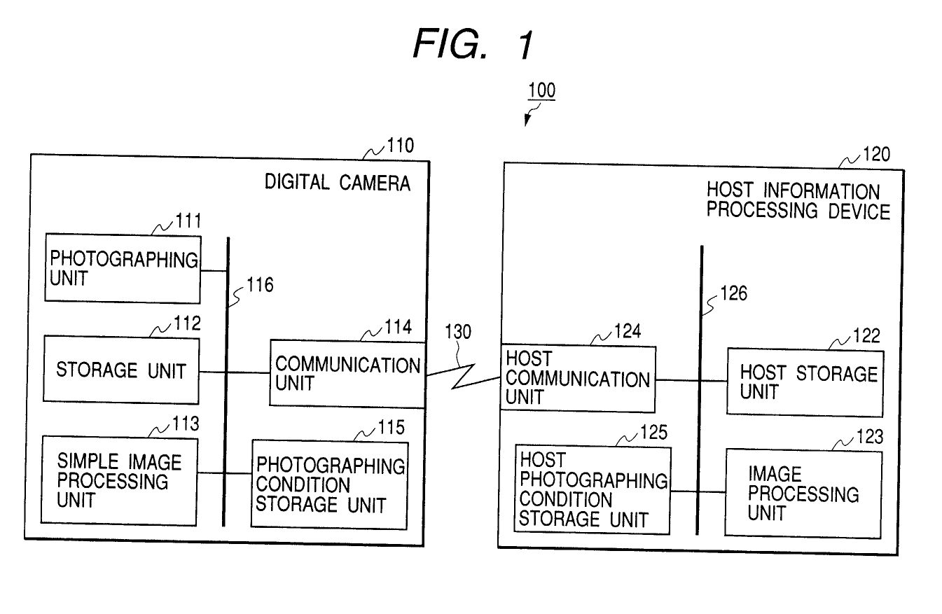

The present invention can be applied for example to a digital camera system 100 as shown in FIG. 1.

The digital camera system 100 is composed, as shown in FIG. 1, of a digital camera 110 and an information processing device (host information processing device) 120 which are so connected as to be capable of mutual communication.

In FIG. 1, there is shown only one digital camera 110 for communicating with the host information processing device 120, but such configuration is not restrictive and there may be adopted plural digital cameras.

The digital camera 110 is provided with a photographing unit 111 including a lens, a shutter, a CCD constituting an image pickup element, an A/D conversion chip (not shown) etc., a simple image processing unit 113 for applying image processing (simple image processing to be explained later) to the photographed image data obtained in the photographing unit 111, a storage unit 112 for storing the photographed image data after the simple image processing in the simple image processing unit 113, a photographing condition storage unit 115 for storing the photographing condition in the photographing unit 111, and a communication unit 114 for executing communication for example of data and commands with the host information processing device 120 through a communication medium 130, and these component units are connected by an internal bus 116 for mutually exchanging data and commands.

The storage unit 112 for storing the process result data (photographed image data after simple image processing) from the simple image processing unit 113 is also used as a working memory for the simple image processing unit 113 in executing the simple image processing.

The simple image processing unit 113 executes, on the photographed image data obtained as a result of a photographing operation in the photographing unit 111, image processing requiring a relatively small amount of calculation and a relatively small memory capacity with a limited electric power consumption.

The result obtained by such image processing (simple image processing) will hereinafter be called “simple image processing result data”.

On the other hand, the host information processing device 120 is provided with a host communication unit 124 for communicating data and commands with the digital camera 110 through the communication medium 130, an image processing unit 123 for applying image processing to the simple image processing result data received from the digital camera 110 through the communication unit 124, a host photographing condition storage unit 125 for storing the photographing condition data (data of the photographing condition in acquiring the above-mentioned simple image processing result data) received from the digital camera 110 through the communication unit 124, and a host storage unit 122 which is also used as a working memory for the image processing unit 123 in executing the image processing, and these component units are connected through an internal bus 126 for exchanging data and commands.

The image processing unit 123 is provided with a high speed calculating power and is capable of high-speed image processing on the image data.

The host storage unit 122 has a large memory capacity and is capable of high-speed writing and reading.

In the digital camera 110 of the present embodiment, it is assumed that the simple image processing unit 113 executes minimum image processing (gain control, color conversion, white balance adjustment etc. which are minimum necessary for obtaining a satisfactory output from an unrepresented output unit of the main body of the digital camera 110) on the photographed image data obtained from the photographing unit 111, and that thus obtained result (simple image processing result data) is stored in the storage unit 112, but the means for executing such simple image processing is not an essential component in the configuration. Stated differently, the photographed image data obtained in the photographing unit 111 may be directly stored in the storage unit 112.

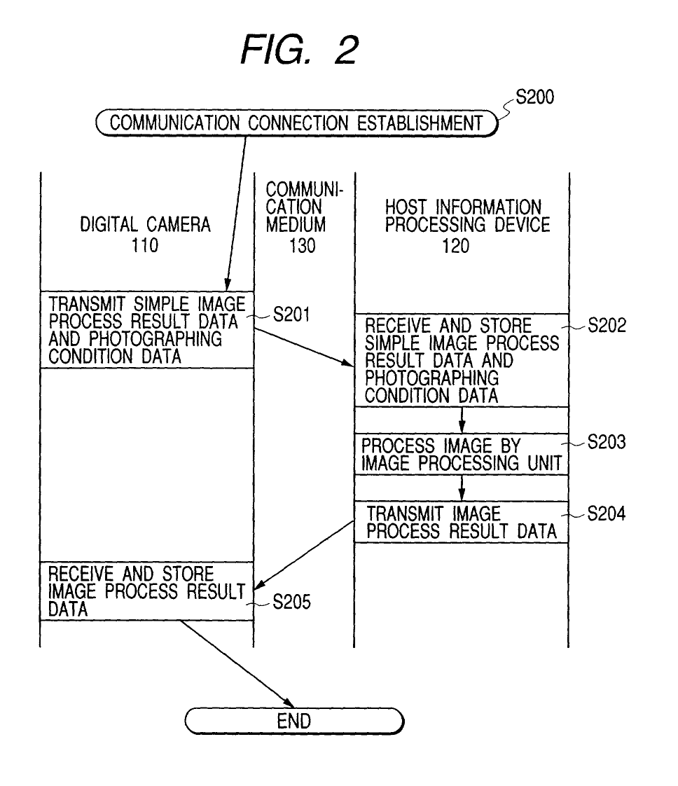

FIG. 2 shows the function of the above-described digital camera system 100:

Steps S200, S201: At first, when the connection of the digital camera 110 and the host information processing device 120 is established through the communication medium 130 (step S200), the simple image processing unit 113 in the digital cameral 110 applies the simple image processing on the photographed image data obtained from the photographing unit 111 and stores the photographed image data after such processing (simple image processing result data) in the storage unit 112.

At this point, the photographing condition data relating to the photographing condition (photographing condition in acquiring the aforementioned transmitted simple image processing result data) in the photographing unit 111 are stored in the photographing condition storage unit 115.

The communication unit 114 reads the simple image processing result data from the storage unit 112 and transmits the data to the host information processing device 120.

When the transmission of the simple image processing result data is completed, the communication unit 114 in succession reads the photographing condition data from the photographing condition storage unit 114 and transmits the data to the host information processing device 120 (step S201).

Step S202: In the host information processing device 120, the host communication unit 124 receives the simple image processing result data and the photographing condition data from the digital camera 110 and stores these data in succession in the host storage unit 122 and the host photographing condition storage unit 125.

Step S203: When the reception and storage of the simple image processing result data and the photographing condition data in the step S202 are completed, the image processing unit 123 reads the simple image processing result data and the photographing condition data respectively from the host storage unit 122 and the host photographing condition storage unit 125, then applies image processing on the simple image processing result data utilizing the photographing condition data as parameters, and stores the simple image processing result data after such image processing (image processing result data) in the host storage unit 122.

Step S204: Then the host communication unit 124 reads the image processing result data, obtained in the step S203, from the host storage unit 122 and transmits the data to the digital camera 110.

Step S205: Then, in the digital camera 110, the communication unit 114 receives the image processing result data from the host information processing device 120 and stores such data in succession in the storage unit 112.

In the present embodiment, as explained in the foregoing, the digital camera 110 and the host information processing device 120 cooperate each other and the image processing for the photographed image data, requiring a large amount of calculation or a large working memory capacity, is executed by the host information processing device 120 equipped with the storage means (122) of a large memory capacity and the image processing means (123) of a high calculation speed, so that the satisfactory image processing result can be obtained even in the digital camera 110 equipped with the storage means (112) of limited memory capacity and the image processing means (113) of low processing speed.

[Second Embodiment]

The present embodiment further specifies the configuration of the aforementioned first embodiment.

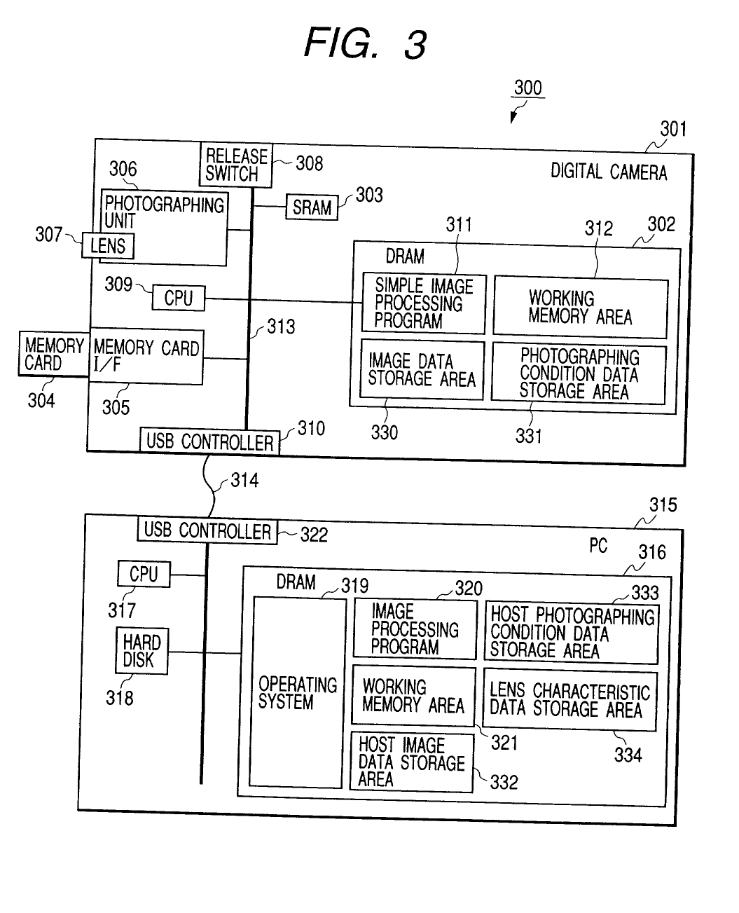

FIG. 3 shows the configuration of a digital camera system 300 of the present embodiment.

The components of the digital camera system 300 correspond to those of the digital cameral system 100 of the first embodiment in the following manner:

digital camera 301: digital camera 110

photographing unit 306: photographing unit 111

DRAM 302, SRAM 303, memory card 304: storage unit 112

simple image processing program 311: simple image processing unit 113

photographing condition data memory area 331: photographing condition storage unit 115

USB controller 310: communication unit 114

internal bus 313: internal bus 116

USB cable 314: communication medium 130

personal computer 315: host information processing device 120

DRAM 316, hard disk 318: host storage unit 125

image processing program 320: image processing unit 123

USB controller 322: host communication unit 124

internal bus 323: internal bus 126

The details of the digital camera system 300 of the present embodiment will be explained in the following.

As shown in FIG. 3, the digital camera system 300 is composed of a digital camera 301 and a personal computer (PC) 315 which are so connected as to be capable of mutual communication.

In the present embodiment, the digital camera 301 is composed of so-called handy type and is so constructed as to store the photographed moving and still images in the form of digital data in a memory card 304 constituted by a non-volatile memory medium.

The digital camera 301 is provided with a photographing unit 306 including a lens 307 etc., a release switch 308 for instructing a photographing operation to the photographing unit 306, a central processing unit (CPU) 309 for controlling the function of the entire digital camera 301, a DRAM (dynamic random access memory) 302 storing a program for controlling the function of the CPU 309, an SRAM (static random access memory) 303, a memory card 304 consisting of a non-volatile memory medium for storing the photographed image data, an interface unit 305 for the memory card 304 (memory card I/F unit), and a USB (universal serial bus) controller 310 for executing communication of data and commands with the PC 315 through a USB cable 314, and these components are mutually connected through an internal bus 313 for exchanging data and commands.

The photographing unit 306 includes, in addition to the lens 307, a shutter, a CCD constituting an image pickup element, a CCD drive circuit, an A/D converter (not shown) etc. and executes a photographing operation in response to the depression of the release switch 308 by the user, and supplies the photographed image signal, obtained by such photographing operation, as digital data.

Such digital data will be called “photographed image data”.

The memory card I/F unit 305 constitutes an interface unit for enabling the digital camera 302 to write and read the data (photographed image data etc.) to and from the memory card 304.

The USB controller 310 constitutes an interface for the digital camera 301 and another equipment (PC 315 in this case) for executing communication of data and commands through the USB cable 314.

The CPU 309 controls the function of the entire digital camera 301 for example by executing the control program stored in the DRAM 302.

The DRAM 302 stores a simple image processing program as the control program for controlling the function of the CPU 309.

Thus the function of applying the simplified image processing (simple image processing) on the photographed image data obtained in the photographing unit 306 is achieved by the CPU 309 which reads and executes in succession the simple image processing program 311 from the DRAM 302.

The simple image processing in the present embodiment includes gain adjustment and gamma correction.

Also the DRAM 302 includes a working memory area 312, an image data storage area 330 and a photographing condition storage area 331.

The working memory area 312 is used for writing and reading necessary data in the execution of various programs, such as the simple image processing program 311, which the CPU 309 reads from the DRAM 302 and executes.

The image data storage area 330 is used for storing the photographed image data obtained in the photographing unit 306, the simple image processing result data obtained by the execution of the simple image processing program 311, the image processing result data transmitted from the PC 315 etc.

The photographing condition storage area 331 is used for storing information on the condition (photographing condition data) at the photographing operation in the photographing unit 306.

On the other hand, the PC 315 can be a personal computer ordinarily employed in the office or the like, but is desirably capable of securing a sufficient calculation speed and a sufficient memory capacity in consideration of the execution of image processing.

In this embodiment, the PC 315 has the sufficient calculation speed and sufficient memory capacity to execute the image processing.

The PC 315 is provided with a central processing unit (CPU) 317 for controlling the function of the entire PC 315, a DRAM (dynamic random access memory) 316 storing a control program for the function control in the CPU 317, a hard disk 318 constituting a non-volatile storage medium, and a USB (universal serial bus) controller 322 for executing communication of data and commands with the digital camera 301 through a USB cable 314, and these component units are so connected through an internal bus 323 as to mutually exchange data and commands.

The USB controller 322 constitutes an interface for the PC 315 and another equipment (digital camera 301 in this case) for executing communication of data and commands through the USB cable 314.

The CPU 317 controls the function of the entire PC 315 for example by executing the control program stored in the DRAM 316.

The DRAM 316 stores various programs such as an operating system (OS) and an image processing program 302 for the function control by the CPU 317.

The programs (such as the operating system 319) stored in the DRAM 316 are loaded from the hard disk 318 into the DRAM 316 at the start-up of the PC 315 and are thus rendered operable.

Since the DRAM is generally capable of high-speed data writing and reading in comparison with other storage means, the DRAM 316 in the present embodiment also serves as a working memory in the execution of various programs.

The image processing program 320 is read from the DRAM 302 by the CPU 317 and is executed in succession, thereby realizing the function of applying the image processing on the image data (simple image processing result data) from the digital camera 301.

The details of the image processing by the image processing program 320 will be explained later.

The operating system 319 manages the data of the storage medium such as the hard disk 318 and the memory card in the unit of a directory or a file.

The operating system 319 also contains a driver software for driving various hardware resources.

The operating system 319 further includes an application program interface (API) whereby the programs stored in the DRAM 316 can exchange data and commands with the hardware resources and with other programs by calling the API of the operating system 319.

The DRAM 326 includes a working memory area 321, a host image data storage area 332, a host photographing condition data storage area 333 and a lens characteristics data storage area 334.

The working memory area 321 is used for writing and reading necessary data (for example an intermediate result of calculation), in the execution of various programs such as the image processing program 320 or the operating system 319 which the CPU 317 reads from the DRAM 316 and executes.

The host image data storage area 332 is used for storing the photographed image data transmitted from the digital camera 301, and the image processing result data obtained by the execution of the image processing program 320.

The host photographing condition storage area 333 is used for storing the photographing condition data transmitted from the digital camera 301.

The lens characteristics data storage area 334 is used for storing information relating to the lens characteristics, to be explained later.

Now there will be given a detailed explanation on the image processing to be executed by the image processing program 320. The image processing program 320 of the present embodiment judges the characteristics of the lens 307 from the photographing condition data (data on the photographing condition in acquiring the simple image processing result data in the digital camera 301) stored in the host photographing condition data storage area 333, and executes, on the simple image processing result data (photographed image data after the simple image processing by the simple image processing program 311 in the digital camera 301), an image processing for correcting the geometrical distortion of the lens 307 (hereinafter called “lens distortion correcting process”) according to the characteristics of the lens 307.

This is because the correction for the geometrical distortion, which particularly appears in the peripheral area of the lens 307 of the digital camera 301, requires a movement of the pixel values and an interpolating process in the two-dimensional arrangement of the digital image data, generally involving a large memory capacity and a large amount of calculation, and is therefore suitable for the present embodiment.

In the present embodiment, the photographing condition data transmitted from the digital camera 301 to the PC 317 contain lens information that can uniquely specify the characteristics of the lens 307.

As an example, the lens information consists of a lens identification number indicating the kind of the lens 307.

Therefore, the lens characteristics data storage area 334 stores information relating to the lens characteristics (a parameter for correcting the lens distortion, based on the geometrical distortion of the lens) corresponding to the lens identification number.

Therefore, in executing the image processing program 320, the PC 317 acquires the lens identification number from the photographing condition data transmitted from the digital cameral 301, then acquires a parameter corresponding to the lens identification number from the lens characteristics data storage area 334, and executes image processing (correction of lens distortion) utilizing such parameter on the simple image processing result data transmitted from the digital camera 301.

In the present embodiment, the photographing condition data may also include, in addition to the aforementioned lens information capable of uniquely specifying the lens characteristics), other data such as the focal length, zoom magnification, exposure time, diaphragm stop, focused position etc.

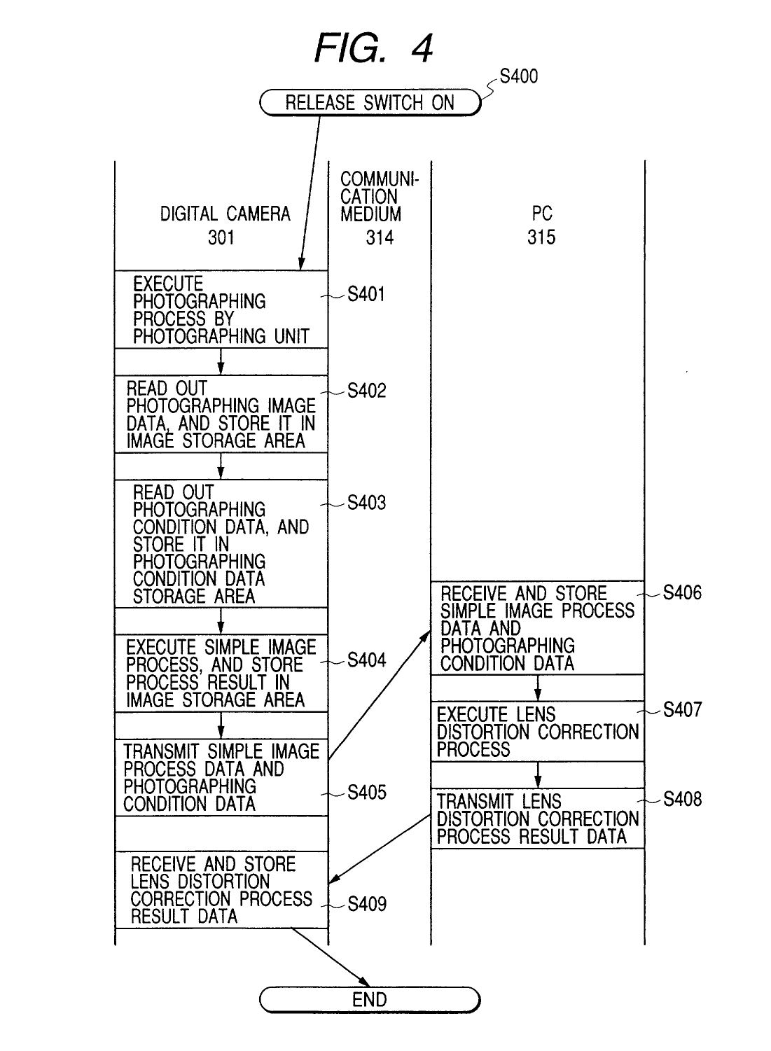

FIG. 4 shows the function of the above-described digital camera system 100.

Step S400: At first, when the power supply to the digital camera 301 is turned on, a camera control program (not shown) is read from the SRAM 303 into the DRAM 302 and is rendered operable after an initialization process.

Step S401: the photographing unit 306 acquires the photographed image data from an object image formed through the lens 307.

Step S402: the CPU 309 reads the photographed image data obtained in the photographing unit 306 and writes the data in the image data storage area 330.

Step S403: the CPU 309 reads the photographing condition data (data containing the lens identification number) from the photographing unit 306 and writes the data in the photographing condition data storage area 331.

Step S404: the CPU 309 executes the simple image processing program 311 thereby reading the photographed image data from the image data storage area 330 and executing the simple image processing such as gamma correction or gain adjustment on the photographed image data, and writes the photographed image data after such processing, as the simple image processing result data, into the image data storage area 330.

Step S405: the CPU 309 reads the simple image processing result data from the image data storage area 330 and transmits the data to the PC 315 through the USB controller 310.

After the transmission of the simple image data result data, the CPU 309 in succession reads the photographing condition data from the photographing condition data storage area 331 and transmits the data to the PC 315 through the USB controller 310.

Step S406: in the PC 315, the CPU 317 stores the simple image processing result data and the photographing condition data, received by the USB controller 322 from the digital camera 301, respectively in the host image data storage area 332 and the host photographing condition data storage area 333.

Step S407: upon completion of the reception of the simple image processing result data and the photographing condition data in the step S407, the CPU 317 executes the image processing program 320 to read the simple image processing result data and the photographing condition data respectively from the host image data storage area 332 and the host photographing condition storage area 333, then to acquire the parameter, corresponding to the lens identification number contained in the photographing condition data, from the lens characteristics data storage area 334, and to apply the image processing utilizing such parameter (lens distortion correcting process) to the simple image processing result data.

Then the CPU 317 stores the simple image processing result data after the above-mentioned image processing, as the image processing result data (lens distortion correcting process result data), in the host image data storage area 332.

Step S408: the CPU 317 reads the image processing result data from the host image data storage area 332 and transmits the data to the digital camera 301 through the USB controller 322.

Step S409: in the digital camera 301, the CPU 309 stores the image processing result data, received by the USB controller 310, in succession in the image data storage area 330.

The present process is terminated after all the image processing result data are stored in the image data storage area 330.

Thus the image data storage area 330 of the digital camera 301 stores the satisfactory image processing result data which are corrected for the lens distortion. Also the image data storage area 330 may be effectively utilized for the next photographing operation by storing the satisfactory image processing result data, present in the image data storage area 330, as a file in the memory card 304.

[Third Embodiment]

In the digital camera system 300 shown in FIG. 3, the digital camera 301 in the present embodiment is not connected, at the photographing operation, with the PC 315 in a state capable of communication therewith. When the digital camera 301 is connected with the digital camera 301 in a state capable of communication therewith after the photographing operation, the digital camera system 300 functions in the following manner.

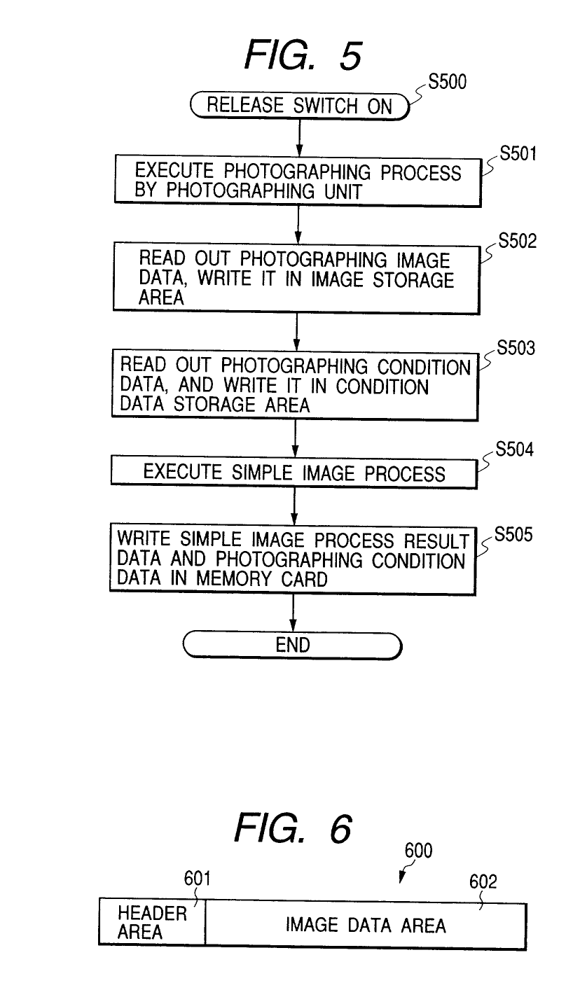

FIG. 5 shows the function of the digital camera 301 in case the release switch 308 is depressed by the user, in a state where the digital camera 301 is not connected to the PC 315 in the communicable manner:

Steps S500, S501: when the release switch 308 is depressed by the user in the above-mentioned state, the photographing unit 306 acquires the photographed image data from the object image formed through the lens 307.

Step S502: the CPU 309 reads the photographed image data obtained in the photographing unit 306 and writes the data into the image data storage area 330.

Step S503: the CPU 309 reads the photographing condition data (data including the lens identification number) from the photographing unit 306 and writes the data in the photographing condition data storage area 331.

Step S504: the CPU 309 executes the simple image processing program to reads the photographed image data from the image data storage area 330, to execute the simple image processing such as gamma correction or gain adjustment on the photographed image data, and to store the photographed image data after such image processing, as the simple image processing result data, in the image data storage area 330.

Step S505: the CPU 309 reads the simple image processing result data and the photographing condition data respectively from the image data storage area 330 and the photographing condition data storage area 331, and stores these data as a single file (hereinafter called “simple image processing result data file”) in the memory card 304, whereupon the present process is terminated.

FIG. 6 shows an example of the format of a simple image processing result data file 600 stored in the memory card 304.

As shown in FIG. 6, the simple image processing result data file 600 includes a header area 601 and an image data area 602.

Consequently the photographing condition data are written in the header area 601, and the simple image processing result data are written in the image data area 602.

The serial operations (photographing operation) shown in FIG. 5 can be executed repeatedly until the available capacity in the memory card 304 for storing the simple image processing result data is used up.

It is assumed that the aforementioned photographing operation can be repeated N times (N photographings can be executed) if the memory card 304 has a sufficient available capacity.

Consequently, after the execution of N photographing operations, the memory card 304 contains N simple image processing result data files.

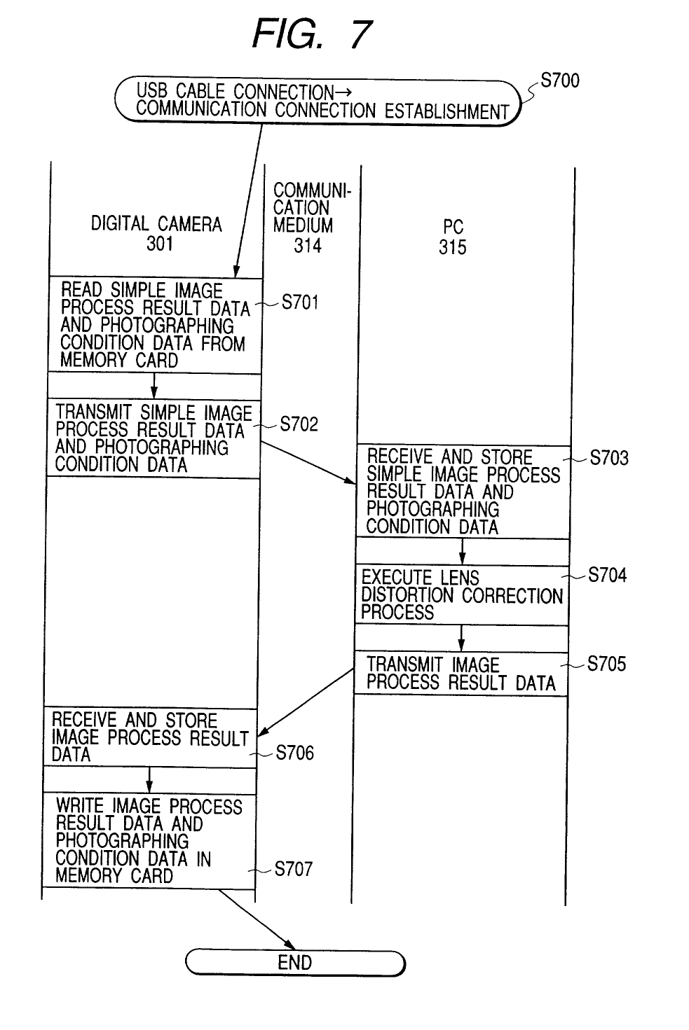

FIG. 7 shows the function of the digital camera 301 and the PC 315 in case the photographing operation is executed in the digital camera 301 by the depression of the release switch 308 by the user in a state where the digital camera 301 is not connected with the PC 315 in a communicable state and the digital cameral 301 is thereafter connected with the PC 315 in the communicable state.

For the purpose of simplicity, it is assumed that the memory card 304 contains only a simple image processing result data file:

Step S700: at first, in the digital camera 301, the CPU 309 recognizes that the USB cable 314 is connected through the USB controller 310 to establish the communicable connection between the digital camera 301 and the PC 315.

In case the digital camera is not connected with the PC after the photographing operation, it is possible to avoid a situation where the data transmission cannot be executed, by displaying a message requesting the connection or a warning that the connection has not been made:

Step S701: the CPU 309 reads the simple image processing result data file from the memory card 304 through the memory card I/F 305, then acquires the photographing condition data from the header area of the simple image processing result data file and stores such photographing condition data in the photographing condition data storage area 331, and also acquires the simple image processing result data from the image data area of the above-mentioned simple image processing result data file and stores such data in the image data storage area 330.

Step S702: The CPU 309 reads the simple image processing result data from the image data storage area 330 and transmits the data to the PC 315 through the USB controller 310.

After the transmission of the simple image processing result data, the CPU 309 in succession reads the photographing condition data from the photographing condition data storage area 331 and transmits such data to the PC 315 through the USB controller 310.

Step S703: in the PC 315, the CPU 317 stores the simple image processing result data and the photographing condition data, received by the USB controller 332 from the digital camera 301, respectively in the host image data storage area 332 and the host photographing condition data storage area 333.

Step S704: upon completion of the reception of the simple image processing result data and the photographing condition data in the step S703, the CPU 317 executes the image processing program 320 to read the simple image processing result data and the photographing condition data respectively from the host image data storage area 332 and the host photographing condition storage area 333, then to acquire the parameter, corresponding to the lens identification number contained in the photographing condition data, from the lens characteristics data storage area 334, and to apply the image processing utilizing such parameter (lens distortion correcting process) to the simple image processing result data.

Then the CPU 317 stores the simple image processing result data after the above-mentioned image processing, as the image processing result data (lens distortion correcting process result data), in the host image data storage area 332.

Step S705: the CPU 317 reads the image processing result data from the host image data storage area 332 and transmits the data to the digital camera 301 through the USB controller 322.

Step S706: in the digital camera 301, the CPU 309 stores the image processing result data, received by the USB controller 310 from the PC 315, in succession in the image data storage area 330.

Step S707: after the storage in the step S706 of all the image processing result data in the image data storage area 330, the CPU 309 reads the image processing result data and the photographing condition data from the image data storage area 330 and the photographing condition data storage area 331 and stores these data in the memory card 304 through the memory card I/F 305, according to the format shown in FIG. 6, whereupon the present process is terminated.

The above-described configuration allows to obtain satisfactory result of image processing even on the image photographed in the digital camera 301 in a state where it is not communicably connected with the PC 315.

In the second and third embodiments, the PC 315 is adopted as a specific example of the host information processing device in the first embodiment, but such configuration is not restrictive.

The host information processing device 108 can be composed, for example, of an exclusive device capable of filing the image data and displaying such image data on a television device or the like.

More specifically, the host information processing device 108 can be composed of any device capable of communicable connection with the digital camera and of image processing.

In the foregoing description, it is assumed that the digital camera is not connected, at the photographing operation, with the PC, but it is also possible to provide the camera with connection detecting means for detecting the connection state with the PC at the transmission of the image data and to store the image data in the memory card in a non-connected state but to automatically start the transmission when the connection state is attained.

The above-described configuration is particularly effective in case the image data are transmitted by wireless communication, since the communication may be hindered by the status of the radio wave. Also even in case of wired communication, the transmission may be automatically started in response to the detection of the connection, thereby reducing the operations of the user.

Also the image processing to be executed on the simple image processing result (in the host information processing device 120 or the PC 315) is not limited to the correction of the lens distortion but may include various image processings, for example a process of synthesizing plural images for generating a panoramic image, a process of synthesizing an image with a template, an object process for example extracting a face area, a color hue adjusting process etc.

In case of a synthesizing process, the above-described configuration is particularly effective for the synthesis utilizing image data only available externally. For example it is possible to obtain, in the camera, a photographed image synthesized with the image data not originally existing in the camera, by setting image data not contained in the camera (for example a frame image or an image of a famous person), according to an instruction from the camera, as the image to be synthesized with the photographed image, then transmitting the photographed image to the external image processing device and receiving the synthesized image.

It is furthermore possible to receive, in the source of the simple image processing result (digital camera 110, 301) from the user, an instruction (for example selection of the content of image processing) for the content of the image processing to be executed in the destination of transmission (image processing to be executed in the host information processing device 120 or the PC 315), and to execute the image processing in the source of transmission according to such instruction.

In the foregoing description, the digital camera and the host device are connected with a communication path utilizing the USB interface, but the present invention is naturally not limited to such embodiment. For example the infrared communication based on IrDA and the wireless communication technology such as Bluetooth may also be employed and are included in the present invention.

The objects of the present invention can naturally be attained also in a case where a memory medium storing the program codes of a software realizing the functions of the host and terminals in the aforementioned first to third embodiments is supplied to a system or an apparatus and the functions of the aforementioned embodiments are realized by a computer (CPU or MPU) of the above-mentioned system or apparatus by reading and executing the program codes stored in the memory medium.

In such case the program codes themselves of the software realize the functions of the aforementioned embodiments, and the memory medium storing the program codes constitutes the present invention.

The memory medium storing such program codes can be, for example, a ROM, a floppy disk, a hard disk, an optical disk, a magnetooptical disk, a CD-ROM, a CR-R, a magnetic tape or a non-volatile memory card.

The present invention also includes not only a case where the functions of the aforementioned embodiments are realized by the execution of the program codes read by the computer but also a case where an operating system or the like functioning on the computer executes all or a part of the actual processes under the control of such program codes thereby realizing the functions of the foregoing embodiments.

The present invention further includes a case wherein the program codes read from the memory medium are once stored in a function expansion board inserted into the computer or a function expansion unit connected to the computer, and a CPU provided in the function expansion board or the function expansion unit executes all the process or a part thereof under the control of such program codes, thereby realizing the functions of the aforementioned embodiments.

In the present invention, as explained in the foregoing, the image processing on the photographed image is executed not in the device or system constituting the source of such image (photographing device) but in an external device with image processing function (information processing device or the like). Therefore, even in case the digital camera constituting the source of the photographed image is incapable of image processing requiring a large calculation amount and a large working memory because of the limitation in the size of the main body, in the electric power consumption or in the memory capacity, a satisfactory photographed image involving such image processing can be obtained through cooperation with the external information processing device capable of image processing of a high level involving a large calculation amount and a large working memory capacity.

As the image processing ability of the digital camera or the like is limited, the present invention for externally executing the image processing becomes more effective as the load of such image processing increases.

The present invention for externally executing the image process also becomes more effective also in case of utilizing the externally held data (for example a template image).

The present invention is not limited to the foregoing embodiments but is subject to modifications and variations within the scope and spirit of the appended claims.

What is claimed is:

1. An image pickup apparatus comprising:
image pickup means for image picking up an object image formed through an optical system and acquiring image information of said object image; and
communication means for transmitting the image information obtained in said image pickup means to an external unit and receiving the image information after an arbitrary image process from the external unit.

2. An apparatus according to claim 1, further comprising:
storage means for storing at least either of the image information to be transmitted to the external unit by said communication means and image information received from the external unit.

3. An apparatus according to claim 2, wherein said communication means causes said storage means to store the image information in a state incapable of communication with the external unit and, when there is detected a state in which transmission to the external unit is possible, reads the image information to be transmitted from said storage means and to transmit the image information to the external unit.

4. An apparatus according to claim 1, wherein said communication means transmits, together with the image information, image pickup condition information which is information relating to a condition at the image picking up in said image pickup means to the external unit and to receive the image information after the arbitrary image processing based on the image pickup condition information from the external unit.

5. An apparatus according to claim 1, wherein said image pickup condition information includes information indicating a characteristics of said optical system.

6. An apparatus according to claim 1, wherein said arbitrary image processing includes a process for correcting a geometrical distortion of said optical system based on characteristics of said optical system.

7. An apparatus according to claim 1, further comprising:
operation means for entering instruction information relating to said arbitrary image processing.

8. An apparatus according to claim 1, wherein said arbitrary image processing includes an image synthesizing process.

9. An information processing apparatus comprising:
communication means for receiving image information transmitted from an external unit; and
image processing means for applying arbitrary image processing to the image information received by said communication means;
wherein said communication means returns the image information after the image processing by said image processing means to a source of transmission of the image information.

10. An information processing apparatus according to claim 9, wherein said communication means is adapted to receive the image information of an object image, obtained by image picking up the object image formed by an optical system and to receive image pickup condition information which is information relating to a condition of said photographing, and said image processing means applies said arbitrary image processing based on said image pickup condition information on the image information.

11. An information processing apparatus according to claim 10, wherein said image pickup condition information includes information indicating characteristics of said optical system.

12. An information processing apparatus according to claim 10, wherein said arbitrary image processing includes a process for correcting a geometrical distortion of said optical system based on characteristics of said optical system.

13. An information processing apparatus according to claim 9, wherein said image processing means executes image processing based on an instruction given in the external unit.

14. An image processing system composed of an image pickup device and an information processing device, wherein:
said image pickup device comprises:
image pickup means for image picking up an object image formed through an optical system and acquiring image information of the object image; and
communication means for transmitting the image information obtained in said image pickup means to an external unit and receiving the image information after an arbitrary image process from the external unit; and
said image processing device comprises:
communication means for receiving image information transmitted from the external unit; and
image processing means for applying arbitrary image processing to the image information received by said communication means;
wherein said communication means is adapted to return the image information after the image processing by said image processing means to a source of transmission of the image information.

15. An image processing method for use in an image processing system composed of a photographing device at least including photographing means, storage means and communication means, and an information processing device at least including communication means and image processing means, the method comprising:
a photographing side transmission step of transmitting image information, obtained by photographing by said photographing means in said photographing device, from said photographing device through said communication means of the photographing side to said information processing device;
an information processing device side step for receiving, in said information processing device, the information transmitted from said image photographing device in said photographing side transmission step by said communication means, then applying image processing by said image processing means to said received image information and transmitting the image information after said image processing to said photographing device by said communication means; and
a storage step of receiving, by said communication means of said photographing side, the image information after the image processing transmitted from said information processing device in said information processing device side step and storing said received image information in said storage means.

16. An image processing method according to claim 15, wherein:
said photographing side transmission step is adapted to transmit, together with said image information, photographing condition information obtained from said photographing means at the photographing by said photographing means to said information processing device by said photographing side communication means; and
said information processing device side step is adapted to receive the image information and the photographing condition information transmitted from said photographing device in said photographing side transmission step by the communication means of said information processing side, and to apply image processing based on said photographing condition information on said image information.

17. An image processing method according to claim 16, wherein said information processing device side step utilizes said photographing condition information as a parameter for the image processing.

18. An image processing method according to claim 16, wherein said photographing condition information includes lens information relating to the characteristics of the lens employed in the photographing by said photographing means, and said information processing device side step is adapted to apply image processing based on said lens information to said image information.

19. An image processing method according to claim 18, wherein said image processing is adapted to correct the geometrical distortion of the lens based on said lens information.

20. An image processing method according to claim 15, wherein said photographing side transmission step includes a step of storing the image information obtained by photographing in said photographing means and, upon detecting the communicable connection with said information processing device by said communication means, to transmit the image information stored in said storage means to said information processing device.

21. An image processing method comprising:
a photographing step of photographing an object image formed by an optical system and acquiring image information of said object image; and
a communication step of transmitting the image information obtained by said photographing step to an external unit and receiving said image information after arbitrary image processing from the external unit.

22. A computer readable memory medium storing a program for realizing an image processing method to be executed by an image processing device, the program comprising:
a photographing instruction code for photographing an object image formed by an optical system and acquiring image information of said object image; and
a communication instruction step of transmitting the image information obtained by said photographing step to an external unit and receiving said image information after arbitrary image processing from the external unit.

23. A computer readable memory medium storing process steps of an image processing method according to claim 15 or 22.
